(19) United States
(12) Patent Application Publication
(10) Pub. No.: US 2012/0033975 A1
(43) Pub. Date: Feb. 9, 2012

(54) APPARATUS AND METHOD FOR MOTOR ROTATION CONTROL WITH AN IR RECEIVER

(76) Inventors: Young Kwan Yoon, Gyeonggi-Do (KR); Suk Ho Shin, Gyeonggi-Do (KR)

(21) Appl. No.: 13/263,944

(22) PCT Filed: Apr. 12, 2010
(86) PCT No.: PCT/KR10/02195

§ 371 Date: Oct. 11, 2011

(30) Foreign Application Priority Data
Apr. 10, 2009 (KR) 10-2009-0031259

(51) Int. Cl. H04B 10/10

(52) U.S. Cl. 398/106

(57) ABSTRACT

A method of controlling a television (TV) mount with a general-purpose remote controller. A signal of the remote controller is intercepted by an infrared ray (IR) receiver, and stored in an internal memory of the IR receiver so as to be used as a control signal of the TV mount. In addition, after a signal is stored the IR receiver in an initial setting mode, the signal may be used as the control signal of the TV mount when a corresponding key of the general-purpose remote controller is pressed.

### TECHNICAL FIELD

One or more aspects of the present invention relate to methods and apparatuses for controlling a television (TV) peripheral apparatus such as a TV mounting apparatus including a motor, by using a signal of a general-purpose remote controller or remote controller for a TV.

### BACKGROUND ART

A remote controller has been applied to and used in home appliances for a long time. The remote controller is very useful to frequently control an operation of a device. For example, in order to control television (TV) channels or volume, a user does not have to be inconvenienced by directly manipulating a TV.

Recently, remote controllers have been used in almost all home automation devices, such as video cassette recorders (VCR), digital versatile disk (DVD) players, computers, audio devices, electric fans, and air conditioners, as well as in TVs. Thus, it is not difficult to find various remote controllers in the home.

When various remote controllers are used, users may be confused with the remote controllers. In general, since a remote controller for a cable TV or digital satellite set-top box, and a remote controller for a DVD player or game console are used, users cannot help being confused by these remote controllers. In order to resolve this inconvenience, a general-purpose remote controller for collectively controlling various devices has been introduced.

Currently, cathode-ray tube (CRT) TVs have been gradually replaced with high-definition flat TVs, such as liquid crystal display (LCD) TVs or plasma TVs. Although a flat TV has high definition and is compact, a user may have difficulty seeing an image displayed on a screen according to an angle at which the user is watching the flat TV.

In order to overcome this difficulty, TV mounting apparatuses for controlling a position of a flat TV are being invented in terms of compactness of the flat TV, that its, the competitiveness of a flat TV that is thin over a CRT TV.

A TV mounting apparatus may be a TV mounting apparatus for adjusting upper and lower slopes of a TV, or a swing-type TV mounting apparatus for adjusting lateral slopes. In addition, a complex-type TV mounting apparatus for adjusting all these slopes is being introduced.

A TV mounting apparatus is attached to a wall on which a flat TV is to be installed, and then the flat TV is mounted on the TV mounting apparatus. Thus, a user may set a TV to a desired position. In this case, the TV mounting apparatus requires a function of automatically adjusting an angle at which the TV is inclined, for user convenience. Compared with a case where the angle is adjusted with a switch connected to the TV mounting apparatus, when the TV mounting apparatus moves or tilts the TV according to a user's command, user convenience may be improved. However, when a separate remote controller for the TV mounting apparatus is used for user convenience, additional costs may be incurred, and the user may be confused with a plurality of remote controllers.

### DISCLOSURE OF THE INVENTION

### Technical Problem

In order to control a television (TV) mounting apparatus for conveniently adjusting a position of a flat TV, a wireless remote controller is required. That is, there is a need for a method of controlling a TV mounting apparatus by using a signal of a general-purpose remote controller or remote controller for a TV, and not any separate remote controller for the TV mounting apparatus.

### Technical Solution

One or more aspects of the present invention provide a method of controlling a television (TV) mount with an infrared ray (IR) receiver, the method including setting the IR receiver in a setting mode by pressing a switch so as to set a key of a remote controller; pressing 1 to n (where n is an integer greater than 1) keys of the remote controller so as to store 2 to n signals for controlling the TV mount in a memory of the IR receiver; and after the IR receiver is set in an operation mode by releasing the setting mode, when any key of the remote controller, which is set in the setting mode, is pressed, outputting a corresponding control signal to the TV mount, wherein the outputting is performed in the IR receiver, wherein the control signal includes at least one signal from among a rotation direction signal of a TV mount motor, a stop signal of the TV mount motor, a setting-position signal of the TV mount motor, and a current position storage signal of the TV mount.

### Advantageous Effects

According to embodiments of the present invention, the rotation of a motor of a simple peripheral device may be controlled by a general remote controller for a television (TV) or a general-purpose remote controller, and not by any separate remote controller for the TV mounting apparatus, thereby reducing costs, and improving user convenience.

### BRIEF DESCRIPTION OF THE DRAWINGS

FIG. 1 illustrates a case where audio/video (AV) devices in the home are controlled by a general-purpose remote controller, according to an embodiment of the present invention;

FIG. 2 illustrates a general-purpose remote controller in detail;

FIG. 3 is a block diagram of an infrared ray (IR) receiver according to an embodiment of the present invention;

FIG. 4 illustrates an IR receiver according to another embodiment of the present invention;

FIG. 5 illustrates an IR receiver according to another embodiment of the present invention;

FIG. 6 is a flowchart of a method of controlling a television (TV) mount by an IR receiver, according to an embodiment of the present invention;

FIG. 7 illustrates a case where a TV mounting apparatus (i.e., a TV mount) is controlled by an IR receiver and a remote controller, according to an embodiment of the present invention; and

FIG. 8 is a flowchart of a method of using a limit switch when a TV mount is controlled with an IR receiver, according to an embodiment of the present invention.

### BEST MODE FOR CARRYING OUT THE INVENTION

According to an aspect of the present invention, there is provided an infrared ray (IR) receiving apparatus for remotely controlling a television (TV) mount by using a signal transmitted from a remote controller for the TV, the IR receiving apparatus including a switch for setting an IR receiver in an initial setting mode in order to set a signal transmitted from the remote controller for the TV as a control signal of the TV mount integrated with the TV, and to set a key of the remote controller; an IR receiving unit for the IR receiver, which receives the signal transmitted from the remote controller; a storage unit for receiving 1 to n (where n is an integer greater than 1) signals of the remote controller through the IR receiving unit, and storing corresponding 1 to n (where n is an integer greater than 1) signals as control signals, in the initial setting mode; and an output unit, when the IR receiving unit receives any one of the 1 to n signals from the remote controller in a normal operation mode, i.e., not in the initial setting mode, for outputting a control signal of the TV mount, which corresponds to the received signal, wherein the control signal comprises at least one signal from among a rotation direction signal of a TV mount motor, a stop signal of the TV mount motor, a setting-position signal of the TV mount motor, and a current position storage signal of the TV mount.

### MODE FOR INVENTION

The present invention will now be described more fully with reference to the accompanying drawings, in which exemplary embodiments of the invention are shown. Only techniques and structures necessary for understanding the present invention will be described and other techniques or structures which may unnecessarily make the present invention unclear will not be described. The terms and words which are used in the present specification and the appended claims should not be construed as being confined to common meanings or dictionary meanings but should be construed as meanings and concepts matching the technical spirit of the present invention in order to describe the present invention in the best fashion.

In the drawings, like reference numerals in the drawings denote like elements.

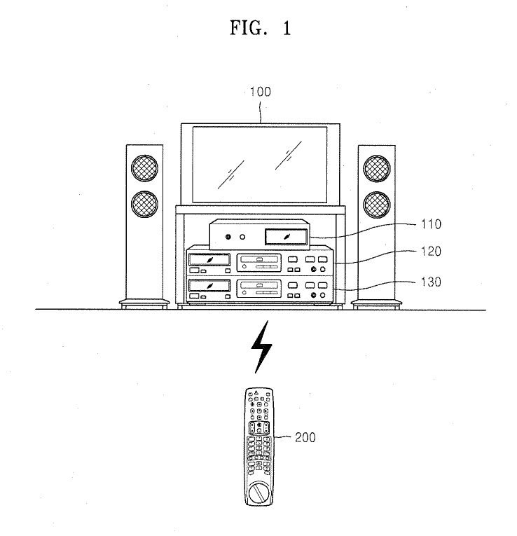

FIG. 1 illustrates a case where audio/video (AV) devices in the home are controlled by a general-purpose remote controller 200, according to an embodiment of the present invention.

At homes in general, a television (TV) 100, a set-top box 110, a digital versatile disk (DVD) player 120, an audio player 130, and the like are installed at one place.

Home appliance companies provide individual remote controllers for respective home AV devices when they sell these home AV devices. Thus, a consumer owns three or four remote controllers. However, in reality, the consumer mainly uses only the general-purpose remote controller 200 or a remote controller for the TV 100.

If there is another device around the TV 100 that is to be remotely controlled and is connected to or separate from the TV 100 in addition to the home AV devices, and another remote controller is provided in order to control the other device, additional costs may be incurred, and a user may also be inconvenienced by having too many remote controllers.

It is assumed that the device to be remotely controlled needs only two to four simple signals. Compared with a case where individual remote controllers are used in order to provide these signals, when the general-purpose remote controller 200 or the remote controller for the TV 100 is used to provide these signals, additional costs do not have to be incurred, and the user may conveniently control the device, in addition to the home AV devices.

According to an embodiment of the present invention, in order to ensure convenience and reduce costs, there is provided an infrared ray (IR) receiver that is miniaturized and is simply connected to a home AV device, such as the TV 100. The IR receiver according to the present embodiment may detect a signal of a remote controller, and may provide the signal to a peripheral device that needs to be individually controlled.

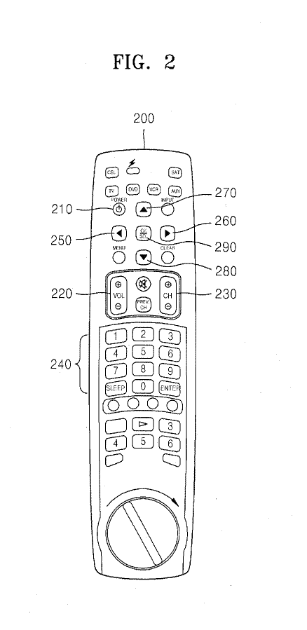

FIG. 2 illustrates the general-purpose remote controller 200 in detail.

The general-purpose remote controller 200 mainly includes a power source 210, a volume control button 220, a channel control button 230, and a general number button 240. In addition, the general-purpose remote controller 200 further includes other buttons for performing various functions.

However, a user who is watching TV does not frequently use other buttons other than the power source 210, the volume control button 220, and the channel control button 230. Thus, according to an embodiment of the present invention, the buttons that are not frequently used may be used as signaling buttons for controlling an external device.

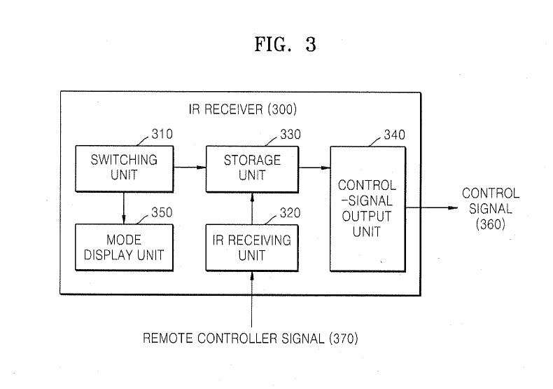

FIG. 3 is a block diagram of an IR receiver 300 according to an embodiment of the present invention.

The IR receiver 300 includes a switching unit 310, an IR receiving unit 320, a storage unit 330, a control-signal output unit 340, and a mode display unit 350. The IR receiver 300 may be installed outside or inside a TV mount. When the IR receiver 300 is installed in the TV mount, the control-signal output unit 340 may be replaced with a control-signal output unit of the TV mount.

The switching unit 310 is used to set the IR receiver 300 to be in an initial setting mode in order to receive an initial signal from a general-purpose remote controller or a remote controller for a TV. If necessary, the switching unit 310 includes a plurality of switches so as to transmit various control signals. When a switch of the switching unit 310 is pressed, the IR receiver 300 receives a signal from a remote controller, and completes preparation for storing a signal corresponding to the received signal as an internal signal. In this case, the mode display unit 350 may be selectively used in order to indicate that the IR receiver 300 is in the initial setting mode. The mode display unit 350 may emit light in the initial setting mode via a light-emitting device, such as a light-emitting diode (LED). Alternatively, the mode display unit 350 may emit red light in the initial setting mode, and the mode display unit 350 may emit green light in a normal operation mode.

An operation in the initial setting mode may be performed as follows. That is, the switching unit 310 includes switches, the number of which is the same as the number of control signals to be transmitted from the IR receiver 400. For example, if two control signals are transmitted, the switching unit 310 may include two switches, namely, first and second switches. In order to store a signal for a first control signal, the first switch may be pressed, or be maintained pressed, and be on standby to receive a first signal from the remote controller. The IR receiver 300 may recognize that the first signal received from the remote controller corresponds to the signal for the first control signal by using hardware without internal complicated software. The received first signal is stored in the storage unit 330 so as to be used as the signal for the first control signal.

Similarly, a signal for a second control signal may also be stored in the storage unit 330. The second switch is pressed, or is maintained pressed, and is on standby to receive a second signal from the remote controller. When the second signal is received, the second signal is stored in the storage unit 330 so as to be used as the signal for the second control signal.

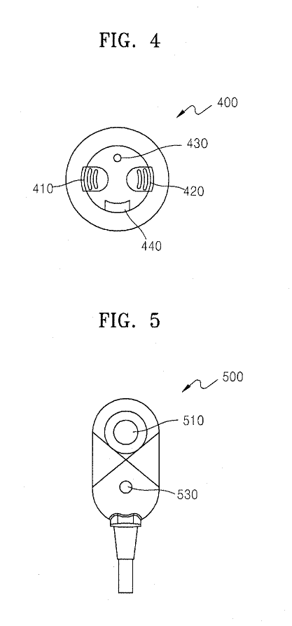

FIG. 4 illustrates an IR receiver 400 according to another embodiment of the present invention.

The IR receiver 400 is of a two-button type IR receiver. A method of initial-setting by the IR receiver 400 is performed as follows.

For example, the IR receiver 400 includes a first switch 410 and a second switch 420. A mode display unit 430 including a lamp that may be embodied by blue and red LEDs.

When the IR receiver 400 is powered-on, if the first switch 410 and the second switch 420 are simultaneously pressed for about two seconds, the IR receiver 400 enters an initial setting mode. The red LED of the mode display unit 430 flashes on and off, which lets a user recognize that the IR receiver 400 is in the initial setting mode. In the initial setting mode, when the user presses the first switch 410 once, the blue LED of the mode display unit 430 flashes on. When the user presses the first switch 410 once again, the red LED flashes on. When the user presses the first switch 410 again so that the blue LED flashes on, if a left key 250 of the remote controller 200 (see FIG. 2) is pressed, a value of the left key 250 is stored in a memory that retains data information even when power is shut off, such as an electrically erasable programmable read only memory (EEPROM). The memory is disposed in the IR receiver 400. An IR receiving unit 440 receives an IR signal from the remote controller 200. According to an embodiment of the present invention, a value of the IR signal is used as a first-direction rotation controlling signal of a motor of a TV mount. Thus, when the IR receiver 400 is in an operation mode, i.e., not in the initial setting mode, if the user presses the left key 250 of the remote controller 200, a TV is tilted forwards or leftwards, according to an operation of the TV mount.

Referring back to the initial setting mode, when the user presses the first switch 410 again, the red LED of the mode display unit 430 flashes on. In this case, when the user presses a right key 260 (see FIG. 2) of the remote controller 200, a value of the right key 260 is stored in a memory of the IR receiver 400. The value of the right key 260 is used as a second-direction rotation controlling signal of the motor of the TV mount. In addition, when the IR receiver is in the operation mode, i.e., not in the initial setting mode, if the user presses the right key 260 of the remote controller 200, the TV may be restored to an original position from a state where the TV is tilted forwards, or the TV may be tilted rightwards, according to the operation of the TV mount.

In order to add several functions to the remote controller 200, values of keys of the remote controller 200 may be stored in the IR receiver 400. When the IR receiver 400 is maintained in the initial setting mode, and the user presses the second switch 420 once, the blue LED of the mode display unit 430 flashes on. Then, when the user presses a preset key 270 (see FIG. 2) of the remote controller 200, a value of the preset key 270 is stored in the memory of the IR receiver 400. Then, in the operation mode, when the user presses the preset key 270, the TV mount moves the TV to a predetermined position. This function will be easily understood with reference to a case where the preset key 270 and a memory key 280 that will be described below are used together.

When the red LED flashes on in the initial setting mode, if the user presses the second switch 420 once again, the red LED flashes on. In this case, when the user presses the memory key 280 (see FIG. 2) of the remote controller 200, a value of the memory key 280 is stored in the memory of the IR receiver 400. In the operation mode, when the user presses the memory key 280, a current position of the TV is stored in the memory of the IR receiver 400. Then, when the user presses the preset key 270 in the operation mode, the TV mount moves the TV to the stored position. The preset key 270 and the memory key 280 are used in order for the user who is watching the TV to easily set the TV to a desired position.

According to the present embodiment, in order to distinguish the initial setting mode, the operation mode, and/or a signal storing operation, different colors emitted by light-emitting devices may be used or light may flash on or off at intervals. That is, modes or operations may be distinguished by using different colors or emitting light at intervals.

FIG. 5 illustrates an IR receiver 500 according to another embodiment of the present invention.

The IR receiver 500 is of a one-button type IR receiver. A method of initial-setting by the IR receiver 500 is performed as follows. A user presses a switch 510 of the IR receiver 500 for two seconds or more. In this case, a period of time that the user may press the switch 510 may vary according to a user's setting.

For example, in the IR receiver 500, a mode display unit 530 includes a lamp that may be embodied by blue and red LEDs.

When the IR receiver 500 is powered-on, if the switch 510 is pressed for about two seconds, the IR receiver 500 enters an initial setting mode. Then, the mode display unit 530 is turned-on, which lets the user recognize that the IR receiver 500 is in the initial setting mode. In the setting mode where the lamp of the mode display unit 530 flashes on, when the user presses the left key 250 of the remote controller 200 of FIG. 2, the value of the left key 250 is stored in a memory that retains data information even when power is shut off, such as an EEPROM. When the left key 250 is pressed, the lamp flashes on and off at very short intervals so as to indicate that a value of a key is stored. When the value of a key is completely stored, and the IR receiver 500 is maintained in the initial setting mode, the IR receiver 500 is on standby to receive a value of another key. Like in the two-button type IR receiver 400, an IR receiving unit (not shown) receives an IR signal from the remote controller 200. According to the present embodiment, a value of the IR signal is used as the first-direction rotation controlling signal of the motor of the TV mount. Thus, when the user presses the left key 250 of the remote controller 200 of FIG. 2 in the operation mode, i.e., not in the initial setting mode, the TV is tilted forwards or leftwards, according to an operation of the TV mount.

In the initial setting mode, when the user presses the right key 260 of the remote controller 200 of FIG. 2 again, the value of the right key 260 is stored in the memory of the IR receiver 500. When the lamp flashes on and off at very short intervals, the value of the right key 260 is stored in the memory of the IR receiver 500. The value is used as the second-direction rotation controlling signal of the motor of the TV mount. In the operation mode, i.e., not in the initial setting mode, when the user presses the right key 260 of the remote controller 200, the TV may be restored to an original position from a state where the TV is tilted forwards, or the TV may be tilted rightwards, according to the operation of the TV mount.

In order to add several functions to the remote controller 200, values of keys of the remote controller 200 may be stored in the IR receiver 500. When the IR receiver 500 is maintained in the initial setting mode, and the user presses the preset key 270 of the remote controller 200, the value of the preset key 270 is stored in the memory of the IR receiver 500. Then, in the operation mode, when the user presses the preset key 270, the TV mount moves the TV to a position that is previously stored. This function will be easily understood with reference to a case where the preset key 270 and the memory key 280 that will be described below are used together.

Immediately, when the user presses the memory key 280 of the remote controller 200, the value of the memory key 280 is stored in the memory of the IR receiver 500. Then, when the user presses the memory key 280 in the operation mode, a current position of the TV is stored in the memory of the IR receiver 500. Then, when the user presses the preset key 270 in the operation mode, the TV mount moves the TV to the stored position. The preset key 270 and the memory key 280 are used in order for the user who is watching the TV to easily set the TV to a desired position. As described with reference to FIG. 4, the lamp of the mode display unit 530 flashes on and off whenever the preset key 270 and the memory key 280 are pressed, which indicates that a value of a key is being input, and then the lamp stops flashing on and off, which indicates that the value of the key is completely input.

In short, the user presses the switch 510 for a preset period of time so that the IR receiver 500 may enter the initial setting mode. The lamp of the mode display unit 530 indicates that the IR receiver 500 is in the initial setting mode. According to a preset rule, whenever a key of the remote controller 200 is pressed, the lamp flashes on and off so as to indicate that a value of the pressed key is stored in the IR receiver 500. In addition, when the value of the key is completely input and stored, the user may press the switch 510 for the preset period of time so as to terminate the initial setting mode. Alternatively, when the user presses a predetermined number of keys of the remote controller 200, the initial setting mode may be automatically terminated.

According to a user's setting, when the user presses a switch for a predetermined period of time, the IR receiver 400 or 500 may be restored to the initial setting mode, or the IR receiver 400 or 500 may be changed between the initial setting mode and the operation mode by using a toggling method of the switch. In each case, the user may check a current mode of the IR receiver 400 or 500 with the naked eye on the mode display unit 430 or 530.

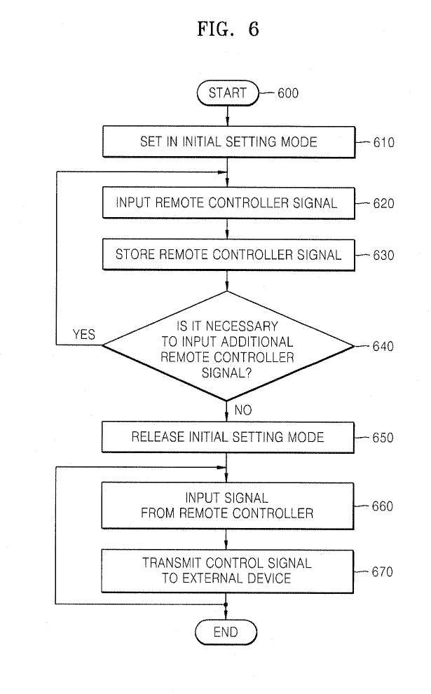

FIG. 6 is a flowchart of a method of controlling a TV mount by an IR receiver, according to an embodiment of the present invention.

A user sets the IR receiver in an initial setting mode with a switch of the IR receiver (operation 610). For example, when the user presses two switches of the IR receiver simultaneously, the IR receiver may enter the initial setting mode. Alternatively, when the user presses a single switch so that a lamp of the IR receiver flashes on, the IR receiver may enter the initial setting mode. Both two-button type and one-button type IR receivers may be set in the initial setting mode by using various methods.

When the IR receiver enters the initial setting mode, preparation for storing a signal of a remote controller is completed. When a target signal of the remote controller is input to the IR receiver (operation 620), a signal corresponding to the target signal of the remote controller is stored in an internal memory of the IR receiver in order to use the signal as a control signal (operation 630).

In order to use other control signals, signals of the remote controller are repeatedly input to the IR receiver, and corresponding signals are stored in the IR receiver.

When target control signals are completely set in the initial setting mode, the user releases the initial setting mode with the switch of the IR receiver (operation 650). Then, the IR receiver operates in a normal operation mode.

In the normal operation mode, the IR receiver is on standby to receive a signal of the remote controller. In this case, when the signal that is set in the initial setting mode is input to the IR receiver (operation 660), the IR receiver checks the signal and transmits a corresponding signal stored in the memory as a control signal of a TV mount in order to a control a position of a TV (operation 670).

According to the present embodiment, in order to control the position of the TV, the signal transmitted by the IR receiver is used as control signals of various controlling devices in the TV mount. However, alternatively, the signal transmitted from the IR receiver may be used as various control signals of other various apparatuses such as electronic devices, for example, motors, home automation devices, various AV devices.

As long as the IR receiver is powered-on, the IR receiver is on standby to receive a signal of a remote controller. Thus, when the signal of the remote controller is input to the IR receiver, the IR receiver may repeatedly perform the above-described operations.

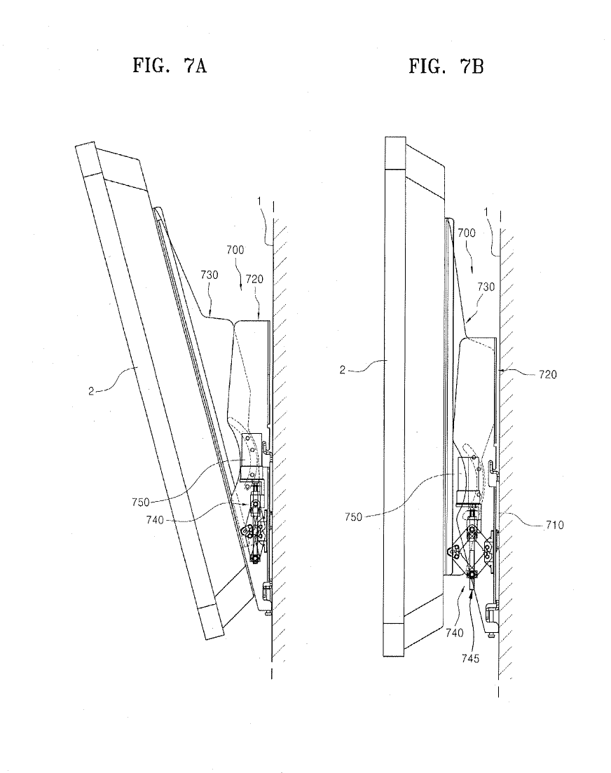

FIG. 7 illustrates a case where a TV mounting apparatus (i.e., a TV mount) is controlled by an IR receiver and a remote controller, according to an embodiment of the present invention.

Recently, TVs using a relatively thin flat-panel, such as a liquid crystal display (LCD) panel or a plasma display panel (PDP), are increasingly being used. This tendency affects a screen size of a TV, and requires a method of attaching a TV to a wall.

When a flat TV having a wide screen is attached to a wall, a space-saving effect may be achieved, which may be agreeable to a user who is watching the TV. However, the user has a difficulty in seeing an image displayed on the screen, not in the front of the TV. With regard to a conventional cathode-ray tube (CRT) TV, a user may rotate the TV to an angle at which the user is watching the TV by rotating a rotary shelf for the TV. However, with regard to the flat TV attached to the wall, it is impossible to adjust the angle of the flat TV.

In order to overcome this problem, a TV is mounted on the TV mounting apparatus and then the TV mounting apparatus (TV mount) is attached to a wall, rather than being attached directly to the wall, and thus the TV may be moved or tilted.

According to the present embodiment, when the remote controller for the TV is mainly used to control the TV, the user who is watching the TV may conveniently control the TV mounting apparatus by using a signal of the remote controller as a control signal of the TV mounting apparatus with the IR receiver.

That is, the TV mounting apparatus generally uses a method of controlling a motor in order to move or tilt the TV mounted on the TV mounting apparatus. If the user uses the remote controller in order to move or tilt the TV, the TV may be conveniently moved or tilted without a separate controller for the TV mounting apparatus.

Referring to FIG. 7A, a display panel 2 such as a TV is mounted on a reference surface 1 that is a wall. The display panel 2 is mounted on a TV mounting apparatus 700. That is, a base plate 710 is fixed to the wall, base brackets 720 are fixed to right and left sides of the base plate 710, and a panel mounting bracket 730 is rotatably coupled to the base bracket 720. The display panel 2 is mounted on the panel mounting bracket 730. In this case, an actuator 740 does not operate, and the panel mounting bracket 730 is inclined at an angle of about 15 to about 20 degrees with respect to the reference surface 1, due to a weight of the display panel 2. Thus, the display panel 2 may be inclined when being initially installed.

A user needs to control a position of the display panel 2, if necessary. That is, the user may want to perpendicularly set the display panel with respect to the reference surface 1 so as to see the display panel 2 in front. The user presses a predetermined key of the remote controller.

In this case, a remote controller signal 370 is input to the IR receiver 300 (see FIG. 3). The remote controller outputs a control signal 360 that corresponds to the remote controller signal 370 and is stored in the remote controller, through the control-signal output unit 340. The control signal 360 is transmitted to a processor (not shown) of the TV mounting apparatus 700 connected to the control-signal output unit 340 of the IR receiver 300. The processor drives a driving motor 750 in order to reduce an inclination for controlling a view angle. As shown in FIG. 7B, a screw 745 of the actuator 740 connected to the driving motor 750 is rotated by driving the driving motor 750, the actuator 740 pushes up a lower portion of the display panel 2, and then the display panel 2 is perpendicularly set with respect to the reference surface 1.

If the user wants to restore the display panel 2 back to a state of FIG. 7A from a state shown in FIG. 7B, the user presses another predetermined key of the remote controller. As described above, the control signal 360 is transmitted to the processor of the TV mounting apparatus 700 connected to the control-signal output unit 340 of the IR receiver 300. The screw 745 of the actuator 740 connected to the driving motor 750 is rotated in an opposite direction according to another control signal, the display panel 2 is tilted again with respect to the reference surface 1.

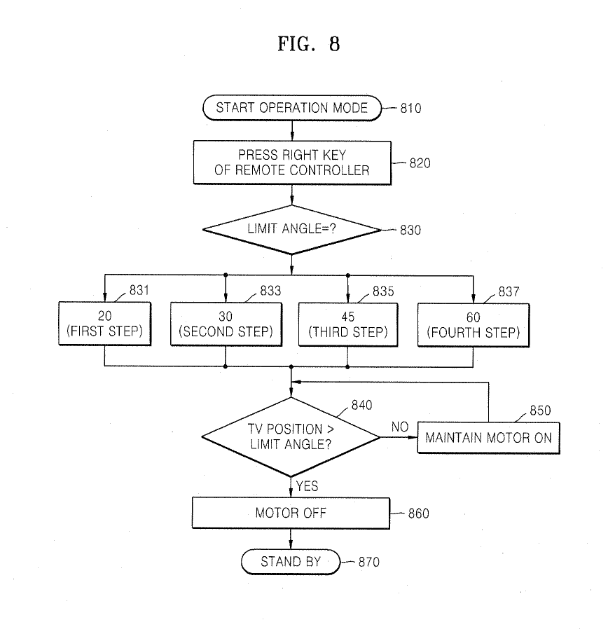

FIG. 8 is a flowchart of a method of using a limit switch when a TV mount is controlled with an IR receiver, according to an embodiment of the present invention.

It is assumed that, when a user presses the right key 260 of the remote controller 200 of FIG. 2, a motor of the TV mount is rotated, and a TV position is changed. In this case, if the TV is unrestrictedly moved to one side regardless of the TV position, it is required to restrict the movement. Thus, the TV mount may include a switch for restricting an angle at which the TV is tilted by using, for example, variable resistance.

With reference to FIG. 8, the method will be described in more detail.

The TV mount may include a limit switch (not shown) for restricting a change in the TV position. The limit switch may use, for example, a four-step sliding type switch. When the limit switch is set in a first step, a restriction change in an angle at which the TV is tilted is 20 degrees. A second step, a third step, and a fourth step may correspond to 30 degrees, 45 degrees, and 60 degrees, respectively.

When the limit switch is set to the second step, if a right key of a remote controller is pressed (operation 820), the TV mount starts moving, and a restriction change is determined according to a state of the limit switch (operation 830). For example, when the limit switch is set in the second step, the limit angle is 30 degrees (operation 833). The processor repeatedly checks whether the TV position satisfies the limit angle (operation 840). When the TV position satisfies the limit angle, the motor is driven so as to move the TV (operation 850). When the TV is tilted by 30 degrees, the motor stops being driven (operation 860), and thus the TV is not moved any more. Then, the mount is on standby to receive another signal of the remote controller (870).

According to the present embodiment, since the user generally uses a remote controller for a TV, the TV mounting apparatus that is closely installed to the display panel 2 and controls the display panel 2 is controlled by the remote controller, together with an IR receiver, but the present embodiment is not limited this case.

However, the IR receiver 300 may be used in any method of controlling a device with a control signal received from the remote controller.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of controlling a television (TV) mount with an infrared ray (IR) receiver, the method comprising:
setting the IR receiver in a setting mode by pressing a switch, in order to set a key of a remote controller;
pressing 1 to n (where n is an integer greater than 1) keys of the remote controller so as to store 2 to n signals for controlling the TV mount in a memory of the IR receiver; and
after the IR receiver is set in an operation mode by releasing the setting mode, when any key of the remote controller, which is set in the setting mode, is pressed, outputting a to corresponding control signal to the TV mount, wherein the outputting is performed in the IR receiver,
wherein the control signal comprises at least one signal from among a rotation direction signal of a TV mount motor, a stop signal of the TV mount motor, a setting-position signal of the TV mount motor, and a current position storage signal of the TV mount.

2. The method of claim 1, wherein, when the rotation direction signal of the TV mount motor is transmitted to the TV mount by the remote controller, the TV mount rotates the motor so as to move a TV to a predetermined position,
wherein, when the stop signal of the TV mount motor is transmitted to the TV mount, the TV mount stops the motor,
wherein, the setting-position signal of the TV mount motor is transmitted to the TV mount, the TV mount moves the TV to a predetermined position, and
wherein, when the current position storage signal of the TV mount is transmitted, the current position is stored.

3. The method of claim 1, wherein, when the rotation direction signal of the TV mount is transmitted to the TV mount from the remote controller, the TV mount rotates the TV mount motor so as to move a TV to a predetermined position,
wherein, when an angle at which the TV is tilted reaches a limit angle that is restricted by a limit switch of the TV mount, the TV stops being tilted at the limit angle that is set by the limit switch.

4. The method of claim 3, wherein the limit switch comprises at least one limit-angle setting switch, and
wherein the at least one limit-angle setting switch has different limit angles, respectively.

5. The method of claim 1, wherein colors of light-emitting devices or light flashes on and off at intervals are used in order to distinguish the setting mode, the operation mode, and a signal storing operation of the IR receiver.

6. An infrared ray (IR) receiving apparatus for remotely controlling a television (TV) mount by using a signal transmitted from a remote controller for a TV, the IR receiving apparatus comprising:
a switch for setting an IR receiver in an initial setting mode in order to set a signal transmitted from the remote controller for the TV as a control signal of the TV mount integrated with the TV, and to set a key of the remote controller;
an IR receiving unit for the IR receiver, which receives the signal transmitted from the remote controller;
a storage unit for receiving 1 to n (where n is an integer greater than 1) signals of the remote controller through the IR receiving unit, and storing corresponding 1 to n (where n is an integer greater than 1) signals as control signals, in the initial setting mode; and
an output unit, when the IR receiving unit receives any one of the 1 to n signals from the remote controller in a normal operation mode, i.e., not in the initial setting mode, for outputting a control signal of the TV mount, which corresponds to the received signal,
wherein the control signal comprises at least one signal from among a rotation direction signal of a TV mount motor, a stop signal of the TV mount motor, a setting-position signal of the TV mount motor, and a current position storage signal of the TV mount.

7. The IR receiving apparatus of claim 6, further comprising a mode display unit for determining whether the IR receiver is in the initial setting mode or the normal operation mode, based on a signal output from the switch, and displaying the initial setting mode or the normal operation mode.

8. The IR receiving apparatus of claim 6, wherein the IR receiving unit comprises control switches, the number of which is the same as the number ‘n’ (where n is an integer greater than 1) of control signals received from the remote controller,
wherein the control signals correspond to the control switches, respectively.

9. The IR receiving apparatus of claim 6, wherein the TV mount comprises a limit switch for restricting a maximum value of an angle at which the TV is tilted.

10. The IR receiving apparatus of claim 9, wherein the limit switch comprises at least one limit-angle setting switch, and
wherein the at least one limit-angle setting switch has different limit angles, respectively.

11. The IR receiving apparatus of claim 6, wherein, when the IR receiving apparatus is in the normal operation mode, and the control signal is the setting-position signal of the TV mount, the TV mount moves the TV to a preset position, and
wherein, when the IR receiving apparatus is in the normal operation mode, and the control signal is the current position storage signal of the TV mount, a current position of the TV mount is stored.

12. The IR receiving apparatus of claim 6, wherein, when the IR receiving apparatus is in the initial setting mode, and a predetermined number of keys of the remote controller are input, a signal corresponding to a preset control signal of the TV mount is stored, and then the initial setting mode is automatically terminated.
